(19) United States
(12) Patent Application Publication
(10) Pub. No.: US 2013/0292352 A1
(43) Pub. Date: Nov. 7, 2013

(54) MOBILE REAR COUNTERWEIGHT DEVICE FOR CRAWLER CRANE

(71) Applicants: Zhi Zhang, Shanghai (CN); Huling Liao, Shanghai (CN); Ce Wang, Shanghai (CN)

(72) Inventors: Zhi Zhang, Shanghai (CN); Huling Liao, Shanghai (CN); Ce Wang, Shanghai (CN)

(73) Assignees: Kunshan Sany Mechanical, Co., Ltd., Jiangsu (CN); Hunan Sany Intelligent Control Equipment Co., Ltd., Hunan (CN)

(21) Appl. No.: 13/266,621

(22) PCT Filed: Jun. 27, 2011
(86) PCT No.: PCT/CN11/01058

§ 371 Date: Apr. 16, 2013

(30) Foreign Application Priority Data
Jan. 19, 2011 (CN) 201120016461.X

(51) Int. Cl. B66C 23/76

(52) U.S. Cl. CPC B66C 23/76
USPC 212/197

(57) ABSTRACT

A mobile rear counterweight device for crawler crane is provided wherein comprising: a slide rail, mounted at the rear of the crawler crane, and one end of the slide rail is connected with the rear of the main platform while the other end of the slide rail is connected with a mast by a pull rod; and, a hoist driving mechanism and a trolley driven by the mechanism, one end of the said mechanism is connected with the end of the slide rail which is near the rear of the main platform, the other end of the mechanism is connected with the trolley, the said trolley bearing counterweight block is mounted on the slide rail. The crane is accessible to the utmost extent to attain the max lifting load and stability by using counterweight blocks, and the barycenter of the crane closes to the center of rotation, and the trolley is driven by a hydro cylinder and a connecting rod mechanism, while the trolley is carrying the counterweight is blocks and going faraway from or near to the barycenter of the crane along the slide rail at the rear of the crane, so that enhances lifting capability of the crane and keeps stability of the crane. The mobile rear counterweight device is easy to assemble, disassemble and transport.

### FIELD OF THE UTILITY MODE

The present utility mode relates generally to a mechanism of cranes, and more specifically it relates to a mobile rear counterweight device for crawler crane.

### BACKGROUND OF THE UTILITY MODE

A crawler crane is either a self-propelled crane or a caterpillar track derrick crane used for construction of high buildings, and the caterpillar treads of the crawler has a large ground contact area, and the crawler crane has a good passing performance, strong adaptability and is capable of walking with weights, very suitable to use in lifting operation on construction field. Nowadays, the crawler cranes at home and abroad maintain stable in lifting heavy objects situation with fixed the rear counterweight blocks or super-lifting counterweight blocks. The disadvantage of the fixed counterweight blocks is it results in less lifting load than that of the super-lifting counterweight blocks. However, the super-lifting counterweight blocks can highly strengthen the crane's lifting capability, but it costs more.

### SUMMARY OF THE UTILITY MODE

It is an object of this utility mode to provide a mobile rear counterweight device for crawler crane which is accessible to the utmost extent to attain the max lifting load by using counterweight blocks, and it enhances the lifting capability of the crane and keep the stability of the crane , and there is no additional cost.

The solution scheme of the present utility mode to overcome the above mentioned disadvantages is as following:

A mobile rear counterweight device for crawler crane, wherein, comprising: a slide rail, mounted at the rear of the crawler crane, and one end of the crawler crane is connected with the rear of the main platform while the other end of the slide rail is connected with a mast by a pull rod; and,

a hoist driving mechanism and a trolley driven by the mechanism, one end of the said mechanism is connected with the end of the slide rail which is near the rear of the main platform, the other end of the mechanism is connected with the trolley, the said trolley bearing counterweight block is mounted on the slide rail.

Said mobile rear counterweight device for crawler crane, wherein, the hoist driving mechanism includes a hydro cylinder and a connecting rod interconnecting with each other, the connecting rod is connected with the trolley, the hydro cylinder is connected with the end of the slide rail which is near the said rear of main platform.

Said mobile rear counterweight device for crawler crane, wherein, the connecting rod is a four-link structure, and the hydro cylinder is a double-acting cylinder.

Said mobile rear counterweight device for crawler crane, wherein, a weight tray is hung on the trolley, of which counterweight blocks are settled at both ends.

Said mobile rear counterweight device for crawler crane, wherein, a locking mechanism is arranged at the inner side of the trolley, a plate is laid on the slide rail, and there are some holes at both sides of the plate along the rail track of the slide rail, the holes are in the same shape and size, whose centers are collinear and are making same spacing.

Said mobile rear counterweight device for crawler crane, wherein, the locking mechanism includes a lockpin plugged into the hole of the plate.

Said mobile rear counterweight device for crawler crane, wherein, there are two trolleys on the two sides of the slide trail side by side, the lockpin is plugged into the hole at the same side of the plate.

The benefits of the present utility mode are as following:

(1) The crane is accessible to the utmost extent to attain the max lifting load and stability by using counterweight blocks, and the barycenter of the crane closes to the center of rotation, and the trolley is driven by a hydro cylinder and a connecting rod mechanism, while the trolley is carrying the counterweight blocks and going faraway from or near to the barycenter of the crane along the slide rail at the rear of the crane, so that enhances lifting capability of the crane and keeps stability of the crane;

(2) The mobile rear counterweight device is easy to assemble, disassemble and transport.

### BRIEF DESCRIPTION OF THE DRAWINGS

The advantages of this utility mode will become apparent upon consideration of the following disclosure of the utility mode, especially when taken in conjunction with the accompanying drawings wherein:

FIG. 1 is a perspective view of the mobile rear counterweight device for crawler crane;

FIG. 2 is a fragmentary enlarged view of the mobile rear counterweight device for crawler crane.

### DESCRIPTION OF THE PREFERRED EMBODIMENTS

The embodiments of the present utility mode will be described in detail hereinafter with reference to the accompanying drawings. The following embodiments show a concrete example of the present utility mode, by which the technical scope of the present utility mode is not limited.

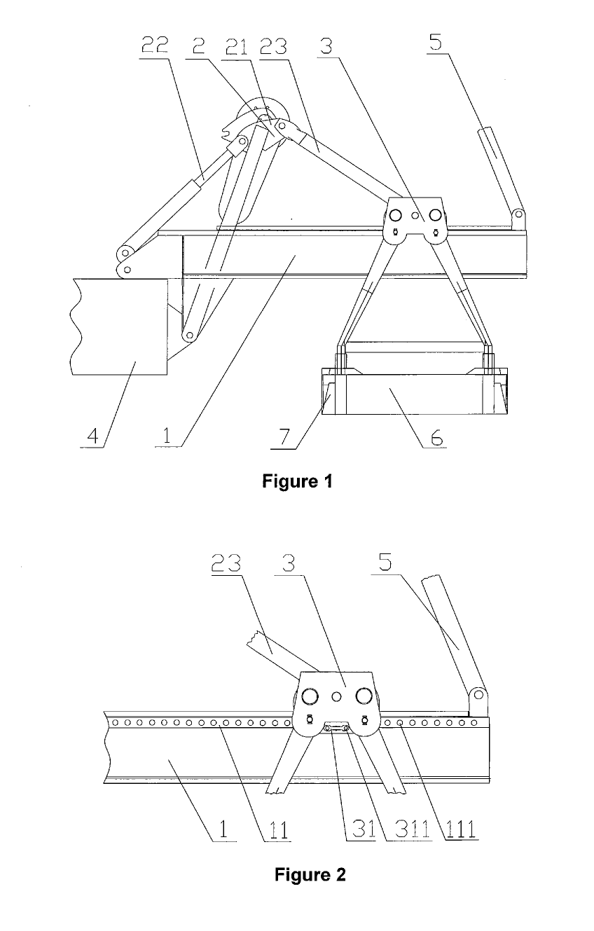

Refer to FIG. 1 and FIG. 2, the mobile rear counterweight device for crawler crane of the present utility mode comprises a slide rail 1, a hoist driving mechanism 2 and a trolley 3 driven by the hoist driving mechanism 2. The slide rail 1 is mounted at the rear of the crawler crane, and one end of the slide rail 1 is connected with the rear of the main platform 4 while the other end of the slide rail 1 is connected with a mast by a pull rod 5. One end of the hoist driving mechanism 2 is connected with the end of the slide rail 1 which is near the rear of the main platform 4, the other end of the driving mechanism 2 is connected with the trolley 3, and the trolley 3 bearing counterweight block is mounted on the slide rail 1. The hoist driving mechanism 2 includes a hydro cylinder 22 and a connecting rod 23 interconnecting with each other by a hinge point 21, and the connecting rod 23 is a four-link structure and is connected with the trolley 3 and the hydro cylinder 22 is a double-acting cylinder. Furthermore, a weight tray 6 is hung on the trolley 3, of which counterweight blocks 7 are settled at both ends, and the weights of the counterweight blocks 7 are preset according to actual needs. Moreover, a locking mechanism 31 is arranged at the inner side of the trolley 3, and a plate 11 with holes 111 is laid on the slide rail 1, and the holes 111 are in the same shape and size, whose centers are collinear and are making same spacing, and the locking mechanism 31 includes a lockpin 311, and the lockpin 311 is plugged into the hole 111 of the plate 11 so as to fix the trolley 3.

In this case, there are two trolleys 3 on the two sides of the slide trail 1 side by side, and the there are some holes 111 at both sides of the plate 11 along the rail track of the slide rail 1, and the lockpin 311 is plugged into the hole 111 at the same side of the plate 11. The aforementioned holes 111 at the same side of the plate 11 are in the same shape and size, whose centers are collinear and are making same spacing.

In working hours, the two trolleys 3 carrying the counterweight blocks go far away from or near to the barycenter of the crane the slide rail 1 at the rear of the crane. When the hydro cylinder 22 extends or retracts, it pushes or pulls the hinge point 21 in the upper end of the connecting rod 23 such that makes the connecting rod 23 extend or retract, driving the trolley 3 to move horizontally along the slide rail 1, i.e. the weight tray 5 and the counterweight blocks 7 can stand in different positions of the rear side of the main platform. When the counterweight blocks are moving into the right position, the lockpin 311 of the locking mechanism 31 at the inner side of the trolley 3 is plugged into the plate 11 on the slide rail 1 to fix the trolley 3, enhancing the stability and safety of the crane.

The above illustrations are only the preferred embodiments of the present utility mode, not to limit the protection scope of the present utility mode, any variations based on the contents disclosed in the Specification and Claims of the present utility mode are within the protection scope of the present utility mode.

1. A mobile rear counterweight device for crawler crane, wherein comprising: a slide rail, which is mounted at the rear of the crawler crane, and one end of the slide rail is connected with the rear of the main platform, while the other end of the slide rail is connected with a mast by a pull rod; and a hoist driving mechanism and a trolley driven by the mechanism, one end of the said mechanism is connected with the end of the slide rail which is near the rear of the main platform, the other end of the mechanism is connected with the trolley, the said trolley bearing counterweight block is mounted on the slide rail.

2. The mobile rear counterweight device for crawler crane as defined in claim 1, wherein, the hoist driving mechanism includes a hydro cylinder and a connecting rod interconnecting with each other, the connecting rod is connected with the trolley, the hydro cylinder is connected with the end of the slide rail which is near the said rear of main platform.

3. The mobile rear counterweight device for crawler crane, as defined in claim 2, wherein, the connecting rod is a four-link structure, and the hydro cylinder is a double-acting cylinder.

4. The mobile rear counterweight device for crawler crane as defined in claim 1, wherein, a weight tray is hung on the trolley, of which counterweight blocks are settled at both ends.

5. The mobile rear counterweight device for crawler crane as defined in claim 1, wherein, a locking mechanism is arranged at the inner side of the trolley, a plate is laid on the slide rail, and there are some holes at both sides of the plate along the rail track of the slide rail, the holes are in the same shape and size, whose centers are collinear and are making same spacing.

6. The mobile rear counterweight device for crawler crane as defined in claim 5, wherein, the locking mechanism includes a lockpin plugged into the hole of the plate.

7. The mobile rear counterweight device for crawler crane as defined in claim 6, wherein, there are two trolleys on the two sides of the slide trail side by side, the lockpin is plugged into the hole at the same side of the plate.
